(19) United States
(12) Patent Application Publication
(10) Pub. No.: US 2019/0059217 A1
(43) Pub. Date: Feb. 28, 2019

(54) Sliding End Spout For an Agricultural Harvesting Combine

(71) Applicant: Tribine Industries LLC, Logansport, IN (US)

(72) Inventors: Robert A. Matousek, Valley Center, KS (US); Reinhold A. Herrman, Manhattan, KS (US); Ray M. Price, JR., Inman, KS (US); Matthew A. Price, Hutchinson, KS (US); Dillon M. Thompson, Newton, KS (US)

(73) Assignee: Tribine Industries LLC, Logansport, IN (US)

(21) Appl. No.: 15/689,328

(22) Filed: Aug. 29, 2017

(51) Int. Cl. A01D 41/12; A01D 90/10; B65G 11/18

(52) U.S. Cl. CPC A01D 41/1217; B65G 65/46; B65G 11/186; A01D 90/10

(57) ABSTRACT

An improved grain unloader for unloading grain from a grain storage bin of a grain harvesting combine is terminated by a hood having a lower grain exiting opening terminating the unloader wherein the hood reversibly moves laterally outwardly for directing the trajectory of the grain flowing therefrom. The hood has a lower grain exiting opening terminating the unloader wherein the hood includes an upper stationary slanted wall and a lower extendable hood portion, wherein the upper stationary slanted wall directs the grain downwardly when the hood is retracted and downwardly, and outwardly when the hood is extended. A linear actuator is attached between the hood and the unloader. Drawer slides connect the unloader and the hood for movement of the hood.

### CROSS-REFERENCE TO RELATED APPLICATIONS

None.

### STATEMENT REGARDING FEDERALLY SPONSORED RESEARCH

Not applicable.

### BACKGROUND

The present disclosure relates to a system and method to unload grain from a grain tank on an agricultural harvester to a transport vehicle, and specifically to a sliding end spout for an articulated agricultural harvester unloader.

At high flow rates approaching 9 bushels/second attainable by the grain cart disclosed in U.S. Ser. No. 14/946,842 filed Nov. 20, 2015, it is necessary to control the trajectory of the grain as it exits from the end of the unload auger. In the case of unloading into a truck that has a narrower (say, 8 feet) opening at its top, the flow must be directed primarily downwardly. If it is not done so, then, as the truck becomes nearly full, the horizontally outward momentum of the grain falling onto the grain already in the truck box, can cause a condition which in the fluid world is called “hydraulic jump”, which results in the grain actually rising above the static level at the far side of the truck box and being projected right over and off the side of the truck onto the ground. The net result is that the truck cannot be “topped off” or even reach an acceptable level of fullness without sincerely reducing the rate of flow. This same scenario holds true for current grain carts that have similar or greater grain flow rates.

Conversely, when unloading into a grain cart that is both taller and wider in the shape of it's “box”, and also typically has a higher “backstop” wall to push the grain flow against, it is often quite useful to have a material flow having a distinctive outward momentum to help fill the wider box and pile up against that backboard to achieve maximum capacity. It also is quite useful to have the stream of grain to be projected further outwardly to better fill the further regions of the wider cart box.

Therefore, there is need for a control mechanism to quickly and controllably move the unloader spout such that both functions are useable on command. Current mechanisms are exclusively dedicated to the hinging of a structure to make this change in trajectory. Such unloaders often get quite large, heavy, and quite long, resulting in issues of clearance when the unloader is in a down or home position and significant weight to support the great unloader length when it is extended outwardly. In both cases, the length of the mechanism (unloader) becomes a clearance issue versus the height of grain carts and perhaps truck boxes. In most cases, the harvester just does not accept the complexity of such units and foregoes the advantages to save the hassle and risk. Grain carts quite often do have such maneuverable spout mechanisms on the larger and more modern units with very high unload rates.

The presently disclosed combine unloader spout overcomes such issues by having a new sliding end spout.

### BRIEF SUMMARY

An improved grain unloader for unloading grain from a grain storage bin of a grain harvesting combine is terminated by a hood having a lower grain exiting opening terminating the unloader wherein the hood reversibly moves laterally outwardly for directing the trajectory of the grain flowing therefrom. The hood has a lower grain exiting opening terminating the unloader wherein the hood includes an upper stationary slanted wall and a lower extendable hood portion, wherein the upper stationary slanted wall directs the grain downwardly when the hood is retracted and downwardly, and outwardly when the hood is extended. A linear actuator is attached between the hood and the unloader. Drawer slides connect the unloader and the hood for movement of the hood.

### BRIEF DESCRIPTION OF THE DRAWINGS

For a fuller understanding of the nature and advantages of the present method and process, reference should be had to the following detailed description taken in connection with the accompanying drawings, in which:

FIG. 1 is a side elevation view of an articulated combine having the disclosed grain cart;

FIG. 2 is an overhead view of the articulated combine of FIG. 1;

FIG. 3 is an isometric view of the articulated combine of FIG. 1;

FIG. 4 is an isometric view of the disclosed rear grain cart of the articulated combine of FIG. 1;

FIG. 5 is an overhead view of the disclosed rear grain cart of the articulated combine of FIG. 1;

FIG. 6 is a bottom view of the disclosed rear grain cart of the articulated combine of FIG. 1;

FIG. 7 is a sectional view taken along line 7-7 of FIG. 5;

FIG. 8 is an isometric view of the grain transfer and unloading equipment of the disclosed rear grain cart of the articulated combine of FIG. 1;

FIG. 9 is a bottom view of the rear grain cart of the articulated combine of FIG. 1;

FIG. 10 is a sectional view taken along line 10-10 of FIG. 5;

FIG. 11 is an isometric view of the grain transfer and unloading equipment of the disclosed rear grain cart of the articulated combine of FIG. 1;

FIG. 12 is sectional view taken along line 12-12 of FIG. 11;

FIG. 12A is a detailed enlarged view of the grain yield sensor, bubbler auger and its drive motor from FIG. 12;

FIG. 13 is a front isometric view of the grain transfer and unloading equipment of the disclosed rear grain cart of the articulated combine of FIG. 1;

FIG. 13A is a detailed enlarged view of the grain transfer and grain yield sensor from FIG. 13;

FIG. 14 is an isometric view of the grain unload auger assembly with its sliding end spout;

FIG. 15 is a top view of the grain unload auger assembly of FIG. 14;

FIG. 16 is a sectional view taken along line 16-16 of FIG. 15;

FIG. 17 is an isometric view from below of the grain unload auger assembly with its sliding end spout of FIG. 14;

FIG. 18 is a bottom view of the grain unload auger assembly with its sliding end spout; and

FIG. 19 is a sectional view taken along line 19-19 of FIG. 18.

The drawings will be described in greater detail below.

### DETAILED DESCRIPTION

The disclosed rear grain cart design addresses the foregoing shortcomings. All of the power needed to drive augers is transmitted to the rear module at hydrostatic pressures and flow rates in only two pump circuits—one circuit for the swinging the unloader auger that moves in and out, and the other circuit running all other augers in the rear grain cart. The two bottom drag augers (front and rear in the grain cart), the drawbar auger carrying grain from the front module to the rear module, the bubbler or inclined tank fill auger receiving grain from the drawbar auger to fill the grain cart grain bin, and the unloader lift auger are driven with power delivered to the rear module by a large hydrostatic motor that drives a common chain box for power distribution. By doing this, any one component of these augers can realize startup or clog-clearing torque (power) that can, perhaps, be as large as the level delivered by a large hydrostatic motor. With the inertias of each of the components being tied to the whole system, startup of a given component can harvest inertia from others that already may be turning, resulting in available power instantaneously exceeding even the output of the main motor (for an impulse period). It, then, becomes the art of configuring drive circuits that allow the main motor driven chain box to distribute the power to the various augers located in the rear grain cart (or rear module). The power, motors, and pumps delivering power to the rear grain cart augers are detailed in U.S. Ser. No. 15/643,685 filed Jul. 7, 2017.

The articulated agricultural harvester or combine (these terms being synonymous and used interchangeably) in the drawings is a Tribine™ harvester (Tribine Industries LLC, Logansport, Ind.) having a grain bin capacity of 1,000 bushels of clean grain and unloads the clean grain at a rate of 540 bushels per minute (9 bushels/second). Normal grain removal from an elevated grain bin uses an unload auger running from the back to the front of the grain bin for transferring grain to the unload arm assembly. When grain is unloaded from the grain bin in this fashion, grain preferentially is removed from the rear of the grain bin; thus, leaving the remaining grain in the front of the grain bin. This can cause weight on the tongue (articulation joint) to increase from near zero to around 8,600 lbs. The disclosed grain cart auger feed system and unload auger system evens out grain removal and unloads virtually all of the grain in the grain cart very rapidly.

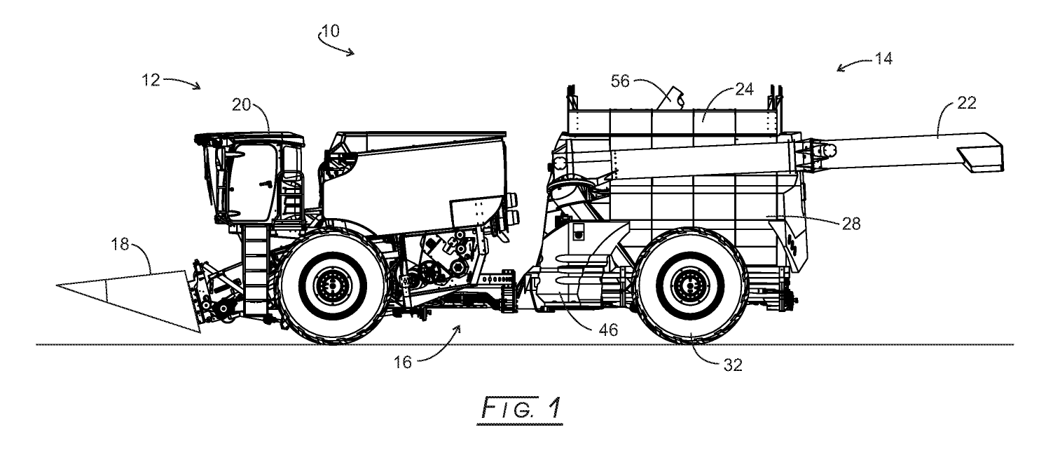

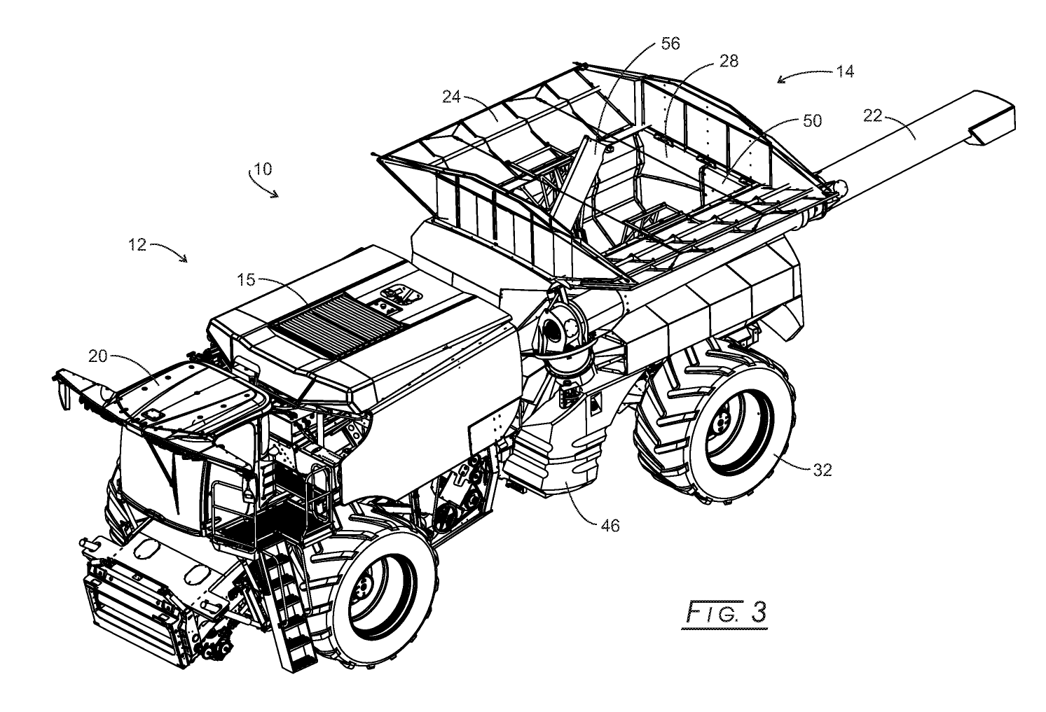

Referring initially to FIGS. 1, 2, and 3, an articulated harvester, 10, consists of a powered forward powered processing unit (hereinafter, PPU), 12, a rear grain cart, 14, and an articulation joint, 16, that connects forward PPU 12 with rear grain cart 14. The details of articulation joint 16 and grain auger assembly 26 are disclosed in commonly owned application Ser. No. 14/946,827 filed Nov. 20, 2015. Forward PPU 12 carries a grainhead, 18, operator's cab, 20, grain cleaning and handling assembly (not shown), and engine (not shown). The grain cleaning and handling assembly in forward PPU 12 is disclosed in commonly owned U.S. Patent No. ______ (application Ser. No. 14/967,691 filed Dec. 14, 2015. Forward PPU 12 is devoid of any grain storage, such being exclusive in rear grain cart 14. While both forward PPU 12 and rear grain cart 14 are shown being carried by wheel assemblies, one or both could be tracked. A screened air inlet, 15, is located atop forward PPU 12.

An off-loading auger assembly, 22, is in the folded home position and being carried by rear grain cart 14. Grain cart 14 also bears a foldable roof, 24, shown in an open position, but which can fold inwardly to cover grain stored in rear grain cart 14. Foldable roof 24 may be made of metal, plastic, or other suitable material, but may be made of durable plastic for weight reduction and easy folding/unfolding. Clean grain is stored in grain cart 14, the sides of which may be made of plastic also in keeping with desirable weight reduction; although, it could be made of metal also at the expense of weight. All plastic parts may be filled with particulate or fiber reinforcement in conventional fashion and could be laminate in construction.

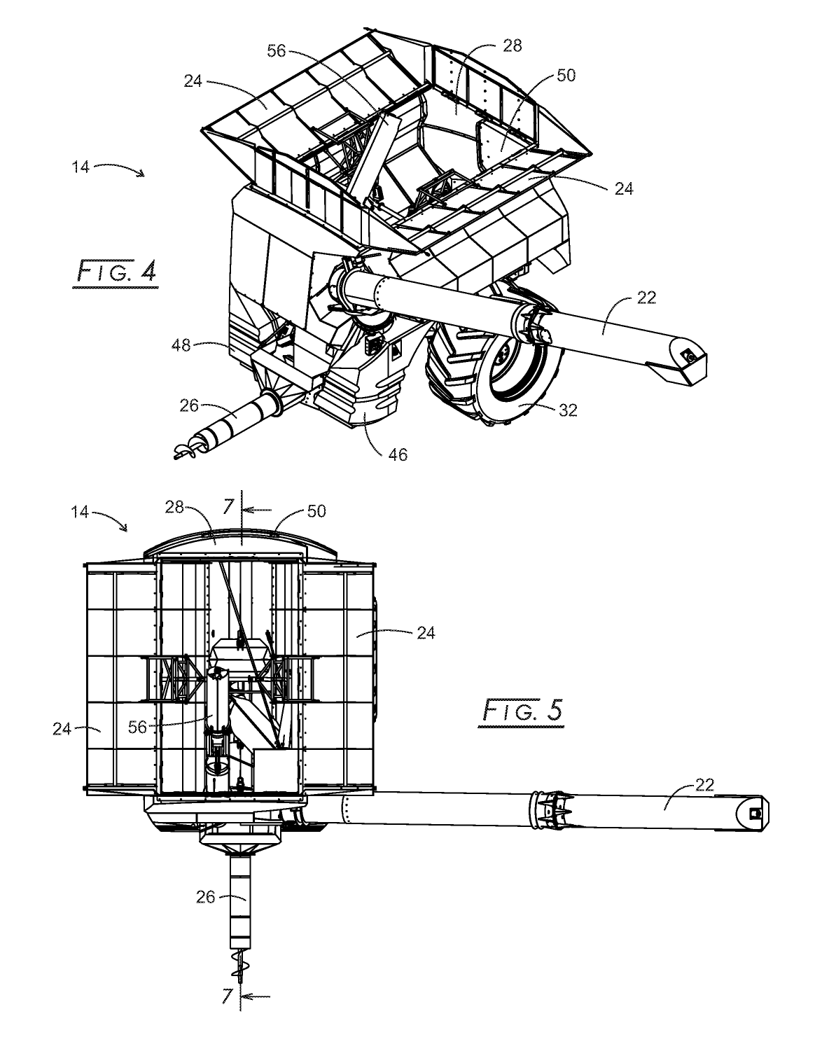

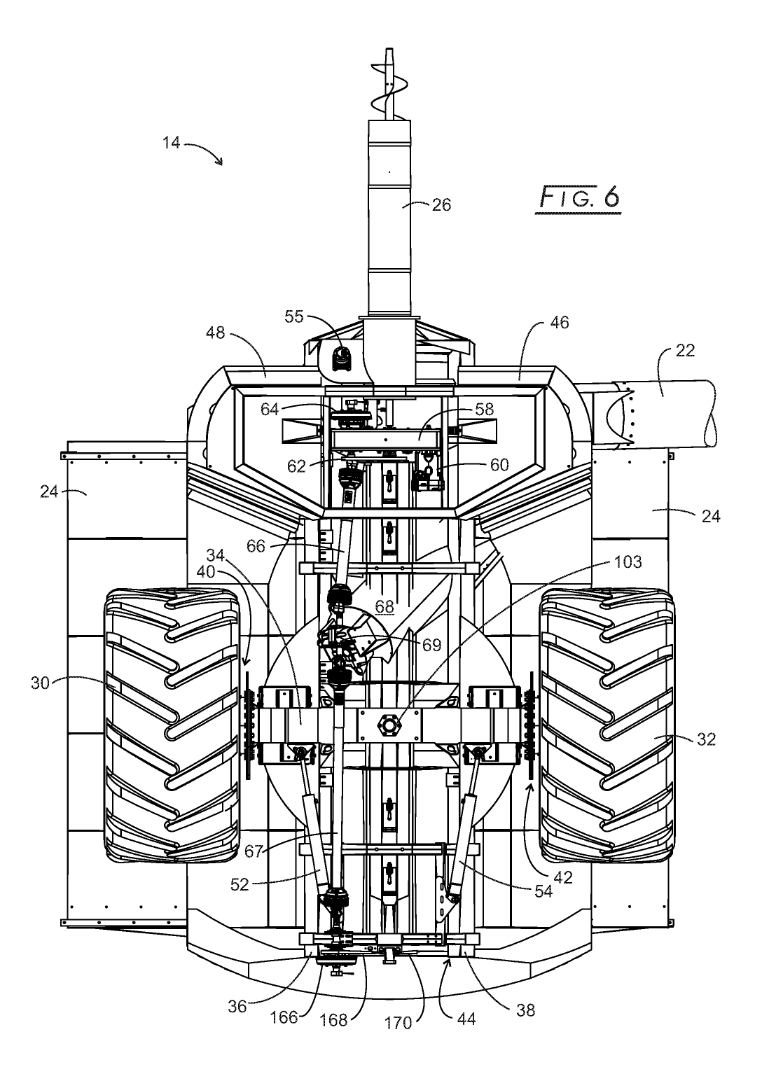

Referring now to FIGS. 4 and 5, clean grain from PPU 12 is fed to grain cart 14 through a grain auger assembly, 26, which is part of articulation joint 16, by a motor not seen in the drawings. As seen in FIG. 6 also, rear grain cart 14 rides on a pair of tired wheel assemblies, 30 and 32, connected by an axle assembly, 34. Hydraulic motor and gear reduction assemblies, 40 and 42, are fitted within each wheel assembly 30 and 32, respectively, for powering rear grain cart 14. The grain bin rests atop frame supports, 36 and 38, which are part of rear grain cart frame assembly, 44. Rear grain cart 14 also carries fuel tanks, 46 and 48 for the engines in forward PPU 12. A hatch, 50, is located at the rear of grain storage bin 28 to provide entry into its interior for repair and maintenance purposes. Steering rod and piston assemblies, 52 and 54, connect to frame assembly 44, as seen best in FIG. 6. While the various auger assemblies are hydraulically powered in the drawings, electrical motors and pneumatic motors could be used. Not all lines and hydraulic motors can be seen in the drawings.

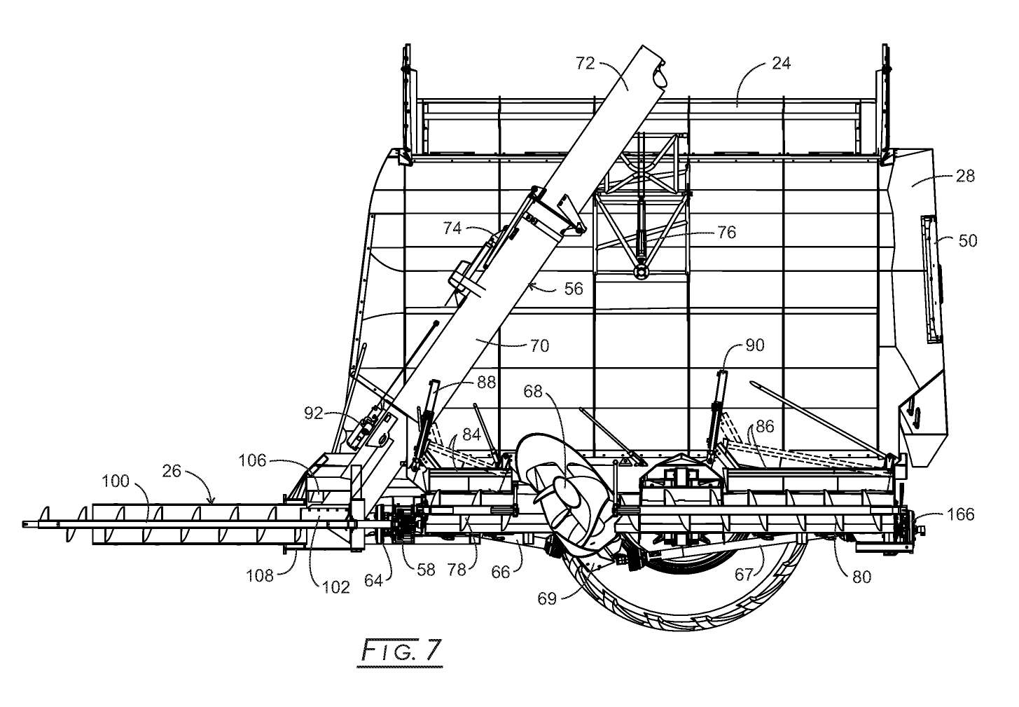

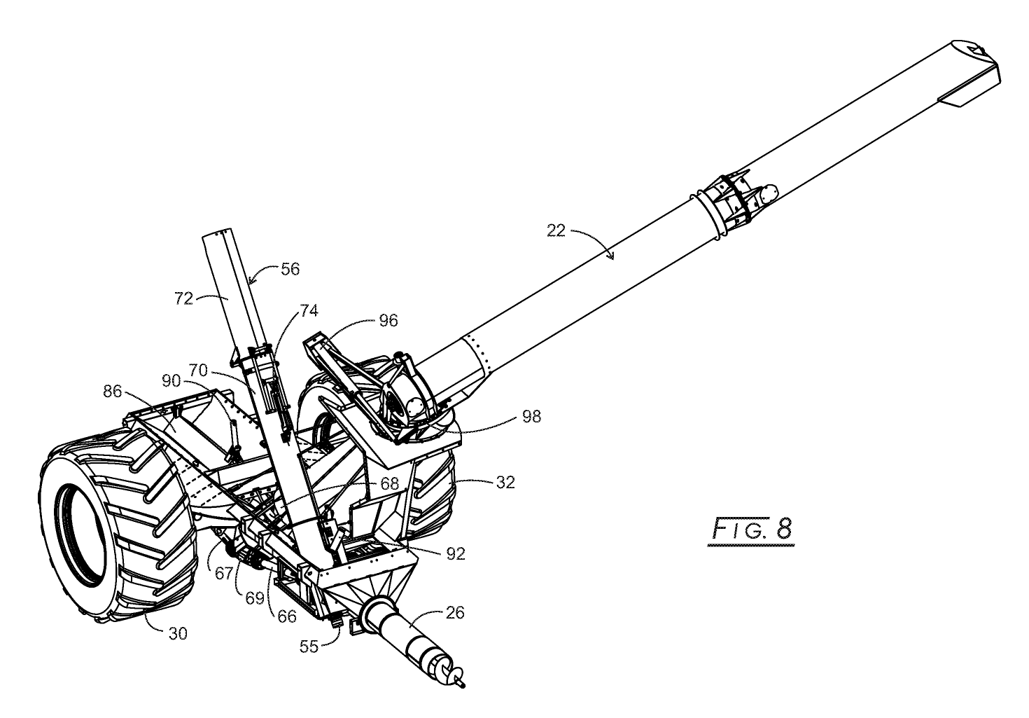

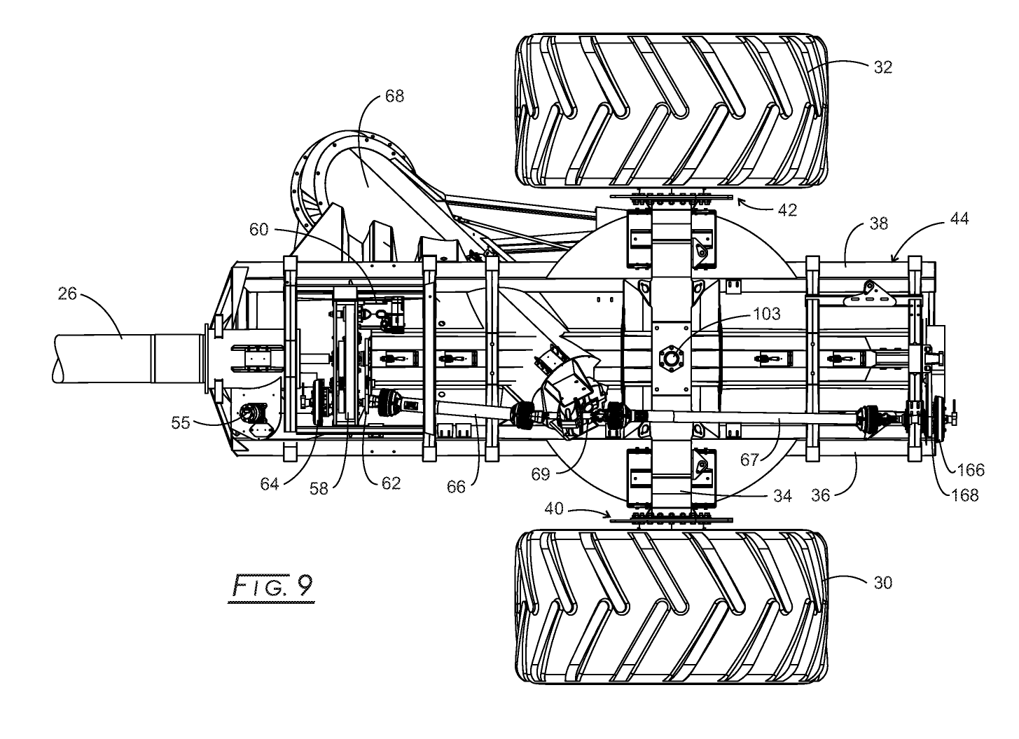

Referring in more detail to FIGS. 6 and 9, a hydraulic motor, 55, powers a bubbler or slanted grain lift auger assembly, 56 (see FIG. 7 and described in detail later herein), which takes the clean grain from PPU 12 and distributes such into rear grain cart 14. A main gearbox, 58, is located adjacent to a main motor, 60, that drives sprockets through a chain drive, 62, for carrying power to various augers in grain cart 14. An electric clutch assembly, 64, is used conventionally to apply and withdraw power from main motor 60. Main motor 60 provides power for bubble auger assembly 56, a drive shaft, 66, for an unloader auger assembly, 68. Grain auger assembly 26 and bubbler auger assembly 56 run so long as main motor 60 is running and not clutched. As such, they provide inertia for all of the other auger assemblies for startup, clog clearing, and other instances when needed. Main motor 60 also powers the auger of grain auger assembly 26 feeding grain from PPU 12 to rear grain cart 14. A rear drive shaft, 67, drives a rear drag auger described later herein. Shafts 66 and 67 are coupled through a gearbox, 69. Shaft 67 is connected at its rear to an electric clutch assembly, 166, and by a chain, 168, to a sprocket, 170, for rotation of rear drag auger 80 (see FIG. 10 also).

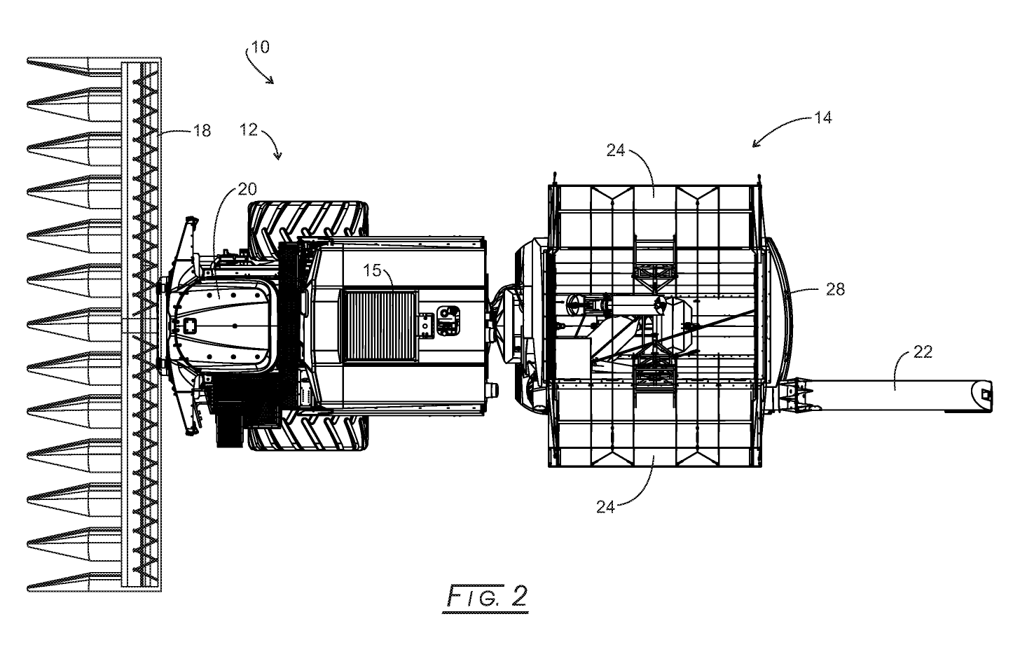

Referring now also to FIG. 7 in addition to FIG. 6, bubbler grain auger assembly 56 is formed of a lower auger section, 70, and an upper auger section, 72, which can be folded by an actuator, 74, in order for roof 24 to be closed by an electric linear actuator, 76, and associated closing structure. A similar electric linear actuator and closing structure is used to close the opposite roof, as seen better in FIG. 2. Ascending bubbler grain auger assembly receives grain from grain auger assembly 26 and in turn dumps the clean grain into grain cart 14.

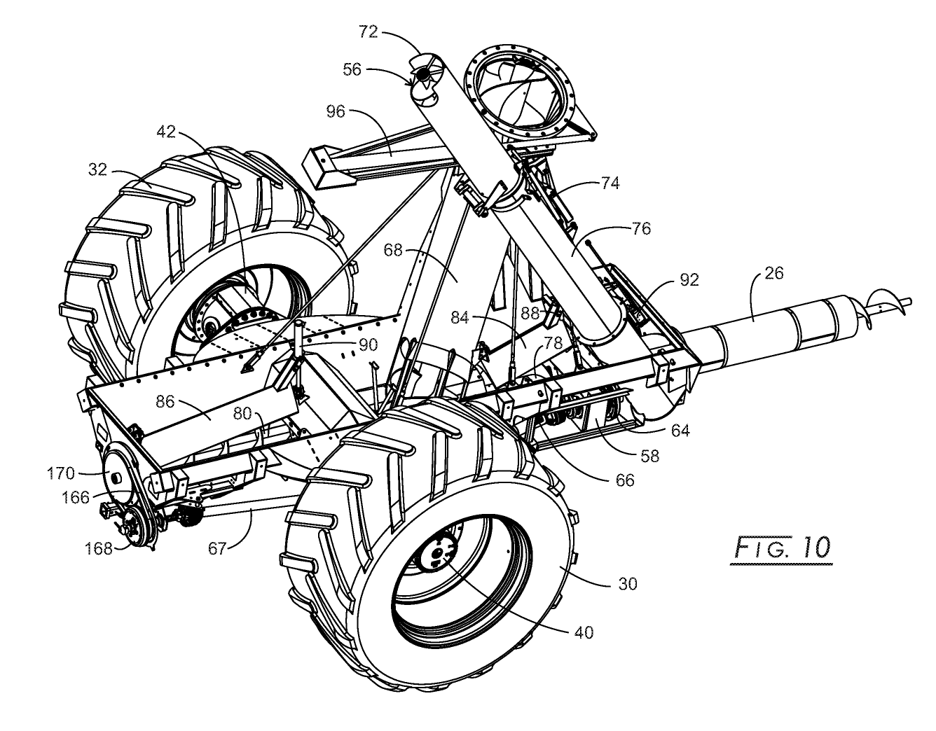

Also seen in FIGS. 7, 8, and 11, are a forward drag grain auger assembly, 78, and rear drag grain auger assembly, 80, both of which drag clean grain towards the central area grain cart 14 where the bottom of a lift auger assembly, 68, which feeds grain off-loading auger assembly 22. Driveshaft 67 powers a clutch assembly, 166, and drives rear drag auger 80. Also seen are doors in phantom, 84, for front drag auger 78 and a door, 86, for rear drag auger 80. The doors are shown in phantom in an up or open position and are raised/lowered by actuators, 88 and 90, respectively. Opening and closing of the doors controls admission of clean grain for movement by the drag augers. Also seen is a moisture sensor assembly, 92, that provides grain moisture readout to the operator. A drive motor, 60, drives lift auger assembly 68 through drive shaft 66. A linear actuator, 96, permits rotation of off-loading auger assembly 22 for off-loading grain and for its folding and unfolding through slew bearing assembly, 98, as described in detail in U.S. Ser. No. 14/946,842, cited above.

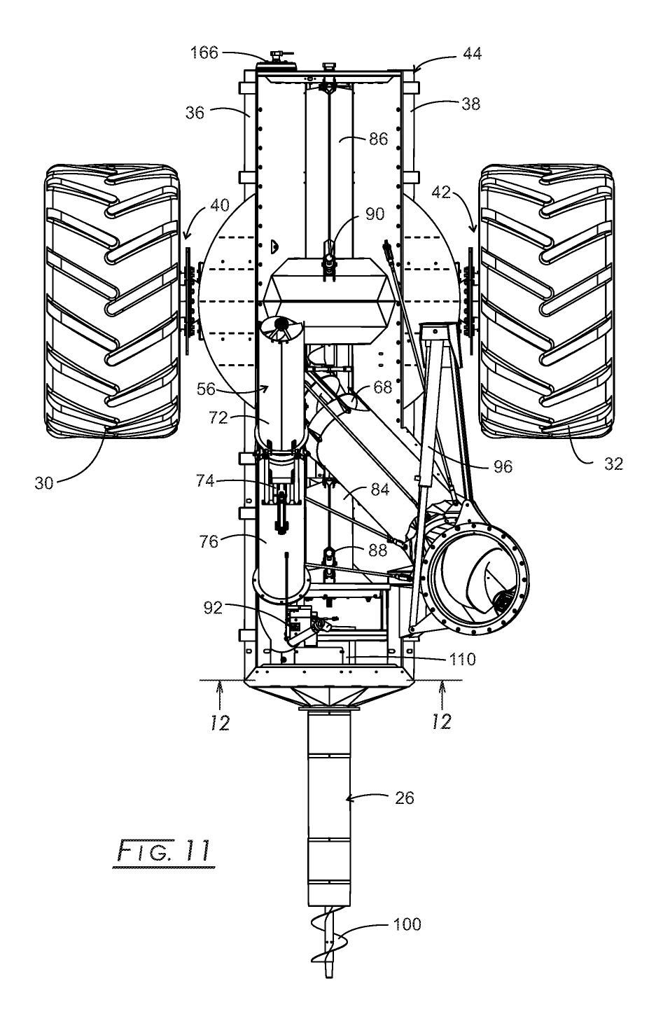

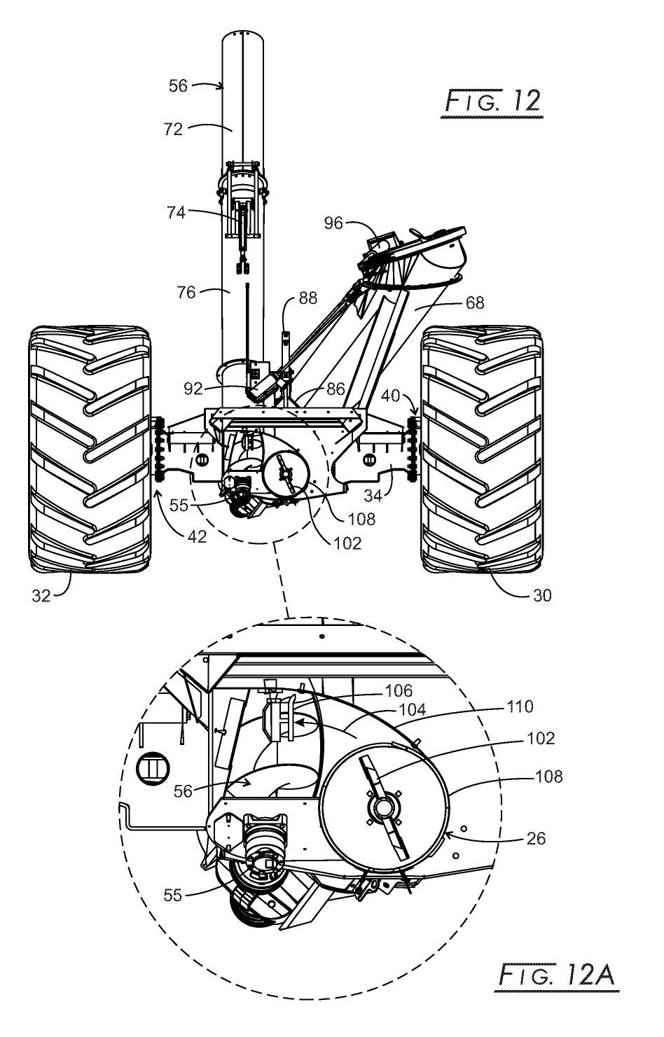

The grain yield sensor assembly is seen if FIGS. 7, 12, 12A, 13, and 13A. In particular grain auger tube assembly 26 moves clean grain from PPU 12 to rear grain cart 14. At the grain cart end of tube 26, auger, 100, housed within auger tube assembly 26 is terminated with a paddle assembly, 102, rotating counterclockwise, as is auger, 100. A portion of the clean grain is flung along the direction of arrow 104 onto an impact sensor pad, 106, that is the flow rate, measuring device common to combine harvester grain elevators in the trade. Grain yield impact sensor pad 106 provides a measure of the amount of clean grain moving into grain cart 14.

In particular, tube 26 is inserted a bit (say, about 6″) into a larger diameter tube, 108. The flights of auger 100 terminate a short distance (say, about 2″) before the end of tube 26. Paddle assembly 102 start where the flights terminate and initially are a smaller diameter (say, about 11″), which, then, increases in diameter to its full diameter (say, about 14″) once inside larger diameter tube 108. This was done because the auger works best (most efficiently) at an RPM that proved to be too slow for the paddles to give the grain sufficient velocity to penetrate into the vertical auger flights at very high grain flow rates. Thereby, the tube surrounding the paddles is of larger diameter than the tube surrounding the auger. The auger works best (considering grain damage) with a clearance of about ¾″, while the paddles are best suited for clearance more near ¼″. The confluence of all these factors leads to the need for differential diameter.

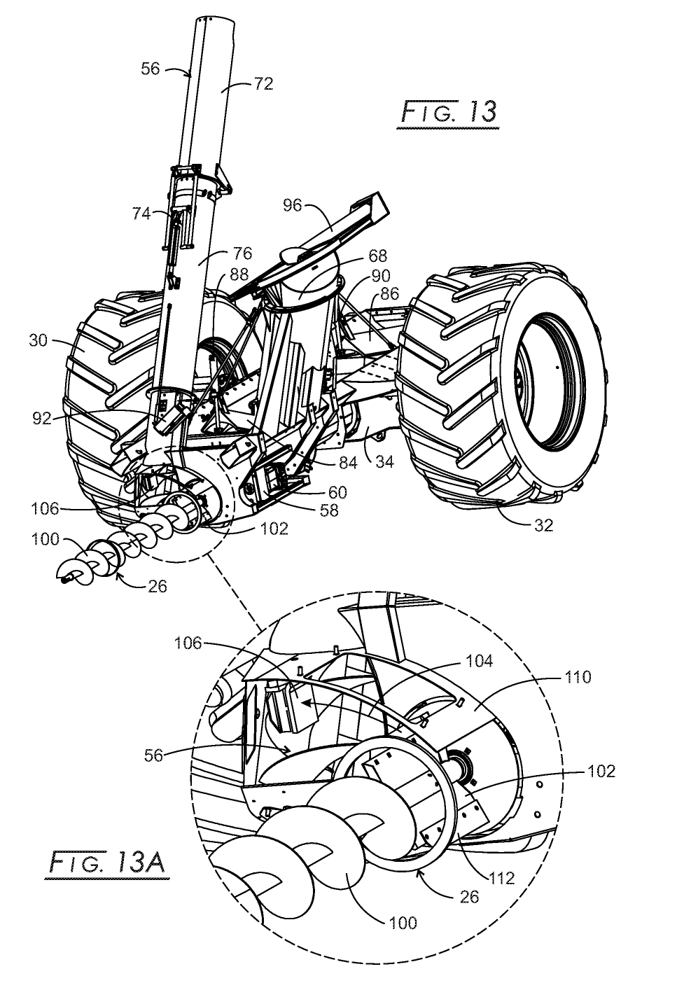

One of the paddles at the tube 26 end is 90° offset to the end of the flight of auger 100 with the other paddle offset 180° from the first paddle. This feature both aids with the release trajectory of the grain, while also giving that transition flow greater capacity of flow volume. At the grain cart end of tube 108, an opening is created and a roof, 110, extends laterally over to and covers sensor 106 and the feed end of bubbler auger assembly 56. With sensor 106 being roughly 5″ wide, and the width of roof 110 being roughly about 14″ wide, and sensor 106 necessarily being about 1″ from the front wall, sensor 106 is sensing between about 30% to 40% (about 36% for the dimensions given) of the total width of grain flow flung by paddle assembly 102, which is sufficient given the normalizing effects of the above configurations. The 1″ gap is necessary to allow flow that is crushed sideways by the plate to be swept past the sensor without negatively affecting sensor reading. It should also be noted both of the paddles carry an end piece, such as an end piece, 112, seen in FIG. 13A, that is back swept in geometry to better facilitate grouping of the grain upon release towards sensor 106.

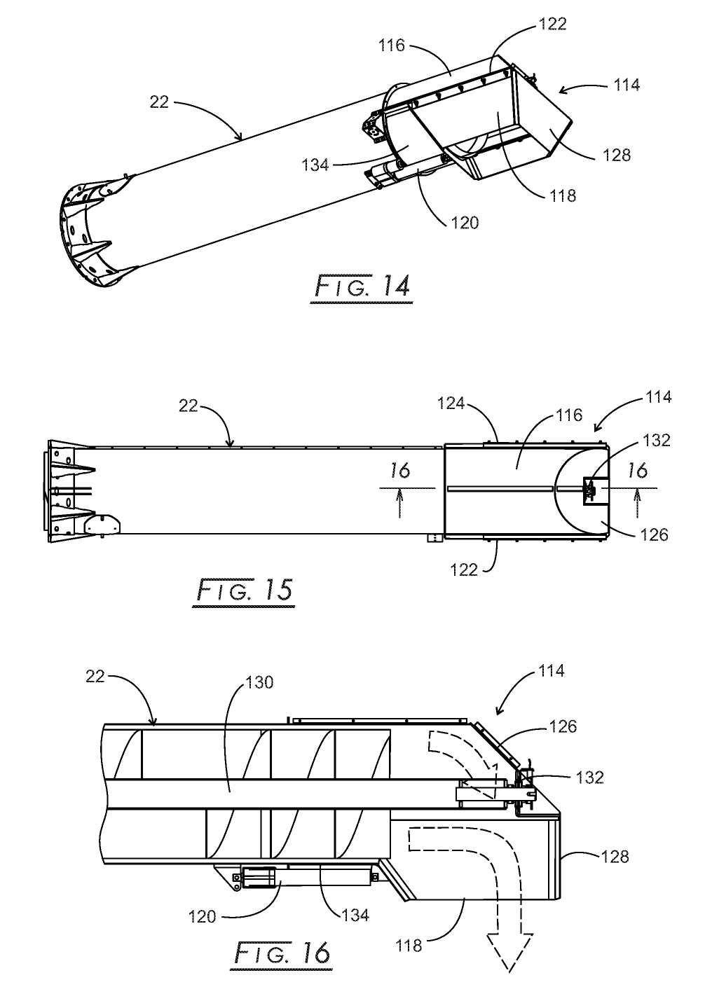

Referring now to FIGS. 14-19, a slidable end spout or hood, 114, terminates grain off-load auger assembly 22, or simply unloader 22. End spout 114 is composed of a static upper spout assembly, 116, and a slidable lower spout assembly, 118, movable by an actuator, 120. Lower slidable spout assembly 118 is mounted to upper static spout assembly 116 by a pair of drawer slides, 122 and 124.

As best seen in FIG. 16, a front or end wall, 126, of static upper spout assembly 116 is tapered (slants) downwardly until it meets the top end of lower slidable spout assembly 118. Worth noting at this time is that front wall 126 starts angling down at the very top of tube 22. Angled end wall 126 serves to deflect the grain in the upper half of tube 22 downwardly due to its inclination, with the momentum of the material flow also causing the flow to project outwardly. However, a front forward wall, 128, of slidable lower spout assembly 118 will stop that outward momentum, turning all flow directly downwardly, and in fact influencing all of the grain flow to turn downwardly and exit the spout traveling nearly all downwardly. Also seen in FIG. 16, is an unload auger, 130, housed within unloader 22. Unload auger 130 terminates with a bearing assembly, 132, carried by slanted wall 126.

It should be understood that hood 114 is tapered in that the hole at the bottom of hood 114 may be less wide and less long than at the top of hood 114, at the greatest diameter of auger tube 22. The size of the hole in the bottom must be such that it will pass all the material flow without congestion or significant slowing of material flow, but small enough that the material exits in a concentrated, uniform, and correctly directed stream downward, this being true of high flow rates, and significantly reduced flow rates such that the material is not “splattered” outside of the receiving container (truck or grain cart, etc.). The phantom arrows in FIG. 16 indicate the predominant grain flow.

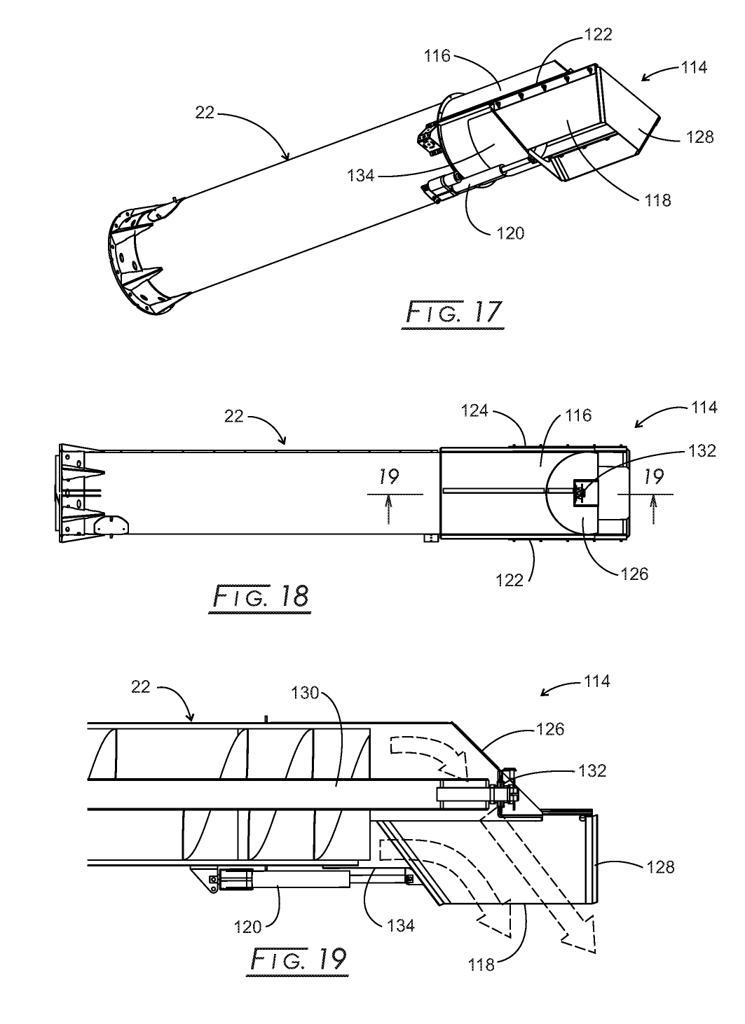

Hood assembly 114 is seen in is retracted position in FIGS. 14-16. In FIGS. 17-19, however, linear actuator 120 has been extended, resulting in lower slidable spout assembly 118 being extended outwardly, say about 12″, relative to static upper spout assembly 116. A skirt, 134, also slides outwardly along with lower slidable spout assembly 118. Skirt 134 in its extended position, covers a portion of the lower opening in spout 114. FIG. 19, then, indicates the direction of grain flow by the phantom arrows with the extended orientation of the hood. The momentum of the grain carries it outwardly with sloped wall 126 turning it somewhat downwardly with the resultant direction of flow being outwardly and downwardly. Since vertical wall 128 now forward of the grain flow, which is primarily directed by sloped wall 126, the material flow is not deflected as downwardly when hood 114 is retracted, and the resultant target of the flow is in fact further outwardly than the end of unloader 22, especially given that unloader 22 typically can be some 4 to 6 feet above the receiving vessel in some cases. It should be understood that linear actuator can move to any location between its home or retracted position and its fully extended position, and at any position therebetween.

While the apparatus and method have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the metric system and all amounts and percentages are by weight, unless otherwise expressly indicated. Also, all citations referred herein are expressly incorporated herein by reference.

1. An improvement to a grain unloader for unloading grain from a grain storage bin of a grain harvesting combine, wherein the improvement comprises:
a hood comprising
(a) a static upper spout assembly having a lower grain exiting opening and terminating the unloader, the static upper spout assembly having a forward downwardly slanted end wall; and
(b) a sliding lower spout assembly mounted to the static upper spout assembly by a pair of drawer slides affixed to the static upper spout assembly and having a lower generally horizontal bottom opening and a front forward wall,
wherein the sliding lower spout assembly reversibly moves laterally outwardly along the pair of drawer slides for directing a trajectory of the grain flowing therefrom downwardly when the sliding lower spout assembly is retracted and downwardly and outwardly when the sliding lower spout assembly is extended.

2. The improvement to a grain unloader of claim 1, wherein a linear actuator reversibly moves the hood sliding lower spout assembly.

3-4. (canceled)

5. The improvement to a grain unloader of claim 1, wherein the hood static upper spout assembly lower grain exiting opening is reduced in size by outward movement of the hood sliding lower spout assembly.

6-11. (canceled)

12. The improvement to a grain unloader of claim 5, additionally comprising a bottom skirt attached to the hood static upper spout assembly and extending outwardly with the hood to cover a portion of the hood static upper spout assembly opening.

13-14. (canceled)
